(19) United States
(12) Patent Application Publication
(10) Pub. No.: US 2025/0024836 A1
(43) Pub. Date: Jan. 23, 2025

(54) INSECTICIDE COMPOSITION, FORMULATIONS AND PROCESS FOR PREPARATION THEREOF

(71) Applicant: Rallis India Limited, Mumbai (IN)

(72) Inventors: Mallikarjunappa SIDDAPPA, Bangalore (IN); Kendappa GOWDRA NANJAPPA, Bangalore (IN); Sai YADDANAPUDI, Bangalore (IN); Rupak PAUL, Bangalore (IN); Vijay Kumar REDDY, Bangalore (IN); Sandesh HEGDE, Bangalore (IN)

(73) Assignee: Rallis India Limited, Mumbai (IN)

(21) Appl. No.: 18/713,752

(22) PCT Filed: Nov. 29, 2022
(86) PCT No.: PCT/IB2022/061513

§ 371 Date: May 28, 2024

(30) Foreign Application Priority Data
Nov. 29, 2021 (IN) 202121055231

(51) Int. Cl. A01N 25/14; A01N 43/56; A01N 43/90; A01N 53/00; A01P 7/04

(52) U.S. Cl. CPC A01N 25/14; A01N 43/56; A01N 43/90; A01N 53/00; A01P 7/04

(57) ABSTRACT

The present disclosure relates to a composition comprising three active ingredients emamectin benzoate, fipronil, lambda-cyhalothrin and one or more inactive excipient(s) selected from the group comprising of a pH stabilizer, an emulsifier, a dispersing agent, stabilizing agent, wetting agent, spreading agent, anti-foaming agent, rheology modifier, solvent, capsule forming agent, quenching agent, super spreader, an anti-freezing agent, a biocide, an anti-caking agent, an inert carrier or combination thereof. Particularly, the present disclosure provides an oil dispersion (OD) formulation, ZC formulation (ZC) and water dispersible granule (WDG) formulation comprising three active ingredients emamectin benzoate, fipronil and lambda-cyhalothrin combination with one or more excipients and process for preparation thereof.

### FIELD OF THE INVENTION

The present invention relates to the technical field of insecticides. In particular the present disclosure relates to an insecticide composition, formulations and a process for preparing the same.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

Pest infestations pose significant adverse effect on economically important agricultural crops such as cotton, brinjal, okra, tomato, chilli, soybean, chick pea and cabbage. Particularly, cotton an important fiber and cash crops and chilli a spice crop which plays a dominant role in the industrial and agricultural economy are infested by major insects such as sucking insects which includes thrips, aphids and jassids and caterpillars such as helicoverpa, spodoptera and pink bollworm.

To address problems associated with infestation with such insects, researchers have been trying to produce an extensive variety of active ingredients and formulations containing such active ingredients effective in controlling insects. Chemical insecticides of many types have been disclosed in the art and a large number of such chemical insecticides are in commercial use. In crop protection, it is desirable in principle to increase specificity and reliability of action of insecticidal active ingredients.

Imidacloprid, emamectin benzoate, ethion, fenpropathrin, fipronil, dimethoate, lambda cyhalothrin, methomyl, spinosad, thiacloprid, diafenthiuron, thiamethoxam, novaluron, lufenuron are compounds independently known in the art for their insecticidal potency. They are disclosed in ‘The Pesticide Manual’ 15^{th} Edition, published 2009 by the British Crop Protection Council, and are also commercially available.

It is known that to seek and obtain registration for a new insecticide compound, including its proposed use rate, is very expensive and time-consuming process. Approval data required must not only include evidence of efficacy at the application rates proposed but also safety of insecticide when applied at the recommended level, also information about the recommended level of insecticide that may be applied per unit of area needs to be provided in view of pressure from governments, as well as for economic and environmental reasons.

It is a common knowledge that with the use of a single insecticide over a period, the insects develop resistance rendering the particular insecticide ineffective for use against a specific insect. Thus, on one hand even more stringent conditions are being placed on the type and use rate of insecticide, while on the other hand approved insecticides available in the art are becoming less and less effective over time against insect pests.

Due to such reasons including the lengthy and cost intensive process, resistance to single insecticide, combinations of known and approved insecticides are attempted.

Two-way combinations of emamectin benzoate with fipronil, fipronil with acetamiprid, lambda cyhalothrin with chlorantraniliprole are known in the art and are in commercial use.

However, certain insect pests are becoming increasingly resistant to even a number of most widely used insecticides formulations with common combination of two ingredients available in the art. Hence, such combinations are also found to be inefficient in controlling insects in effective manner. Other problem with the combination and formulations containing such two active ingredients can be lack of stability and in certain cases increased toxicity for human and animals.

There have been attempts made to provide three way combinations. For example, Chinese patent applications CN 103749517A and CN 103891757A discloses the three way combination comprising emamectin benzoate, fipronil and lambda-cyhalothrin in Examples 1 to 4 and Examples 1 to 3 respectively. However, these patent applications disclose the conventional formulations such as emulsifiable concentrate (EC) and water emulsion or emulsions in water (EW) which have a considerable drawback in that they contain considerable amounts of organic solvents such as xylene which is highly flammable, highly volatile, causes skin irritation and serious eye irritation on contact and may also damage organs through prolonged or repeated exposure and dichloromethane which additionally is carcinogenic and also causes drowsiness or dizziness. Therefore, the conventional formulations which use these toxic solvents are not entirely satisfactory with regards to the ecological and toxicological properties and may also exhibit phytotoxicity and crystallization problems.

Thus, there still remains an unmet great need in the art for environmentally safe, efficacious insecticide composition and formulation which does not use highly flammable, carcinogenic, highly volatile organic solvents, but still is capable of showing one or more of advantages such as stability, synergistic effect, faster onset of insecticide action, a broad-spectrum and longer-lasting action reduced dosage of active ingredients, reduced application rate of the insecticide, reduce or delay the development of resistance in pests, which is necessary to obtain acceptable insect pest control and a process for preparing such insecticide composition and formulation comprising the same.

### SUMMARY OF THE INVENTION

The present invention provides an insecticide composition comprising emamectin benzoate, fipronil and lambda-cyhalothrin.

In an aspect, the present invention provides an insecticide composition comprising the active ingredients emamectin benzoate, fipronil, lambda-cyhalothrin and one or more inactive excipient(s) selected from the group comprising of a an emulsifier, pH stabilizer, a dispersing agent, stabilizing agent, wetting agent, spreading agent, anti-foaming agent, rheology modifier, solvent, capsule forming agent, quenching agent, super spreader, an anti-freezing agent, a biocide, an anti-caking agent, an inert carrier or combination thereof.

The present invention provides an insecticide formulation comprising emamectin benzoate, fipronil and lambda-cyhalothrin.

In an aspect, the present invention provides an insecticide formulation comprising the active ingredients emamectin benzoate, fipronil, lambda-cyhalothrin and one or more inactive excipient(s) selected from the group comprising of a an emulsifier, pH stabilizer, a dispersing agent, stabilizing agent, wetting agent, spreading agent, anti-foaming agent, rheology modifier, solvent, capsule forming agent, quenching agent, super spreader, an anti-freezing agent, a biocide, an anti-caking agent, an inert carrier or combination thereof.

In one aspect, the insecticide composition comprises emamectin benzoate in an amount of from about 0.1% to about 20% w/w, fipronil in an amount of from about 0.1% to about 40% w/w and lambda-cyhalothrin in an amount of from about 0.1% to about 30% w/w of the composition.

In one aspect, the insecticide formulation comprises emamectin benzoate in an amount of from about 0.1% to about 20% w/w, fipronil in an amount of from about 0.1% to about 40% w/w and lambda-cyhalothrin in an amount of from about 0.1% to about 30% w/w of the formulation.

In another aspect, the insecticide formulation comprising emamectin benzoate, fipronil and lambda-cyhalothrin is selected from an oil-dispersion (OD), ZC formulation (ZC), water-dispersible granule (WDG), a water-soluble granule (SG), a wettable powder (WP), a water-dispersible powder (WDP), a water-soluble powder (SP), a granule (GR), an encapsulated granule (CG), a fine granule (FG), a macrogranule (GG), a microgranule (MG), a suspension concentrate (SC), a water-soluble concentrate (SL), a flowable suspension (FS), soil applied granules (SAG), dustable powder (DP), a gel, a water-dispersible tablet (WT), a dispersible concentrate (DC) or a microencapsulated suspension (CS).

In one specific aspect, the insecticide formulation comprising emamectin benzoate, fipronil and lambda-cyhalothrin is an oil-dispersion (OD).

In another specific aspect, the insecticide formulation comprising emamectin benzoate, fipronil and lambda-cyhalothrin is a ZC formulation (ZC).

In yet another specific aspect, the insecticide formulation comprising emamectin benzoate, fipronil and lambda-cyhalothrin is a water-dispersible granule (WDG).

In one aspect, the present disclosure provides a process for preparing oil-dispersion (OD) formulation comprising emamectin benzoate, fipronil and lambda-cyhalothrin.

In one specific aspect, the process for preparing oil-dispersion (OD) formulation comprises the steps of:
a) mixing one or more excipient(s) along with an oil medium to obtain a mixture;
b) adding emamectin benzoate, fipronil and lambda-cyhalothrin to the mixture and continuing to mix to obtain a slurry;
c) passing the slurry through a mill for particle size reduction to obtain a milled slurry; and
d) adding a rheology modifier to the milled slurry and continuing to mix to obtain a homogeneous oil dispersion (OD).

In another aspect, the present disclosure provides a process for preparing a ZC formulation (ZC) comprising emamectin benzoate, fipronil and lambda-cyhalothrin.

In one specific aspect, the process for preparing ZC formulation comprising emamectin benzoate, fipronil and lambda-cyhalothrin comprises the steps of:
i) preparing microencapsulated Lambda-cyhalothrin (CS) comprising steps of:
   a) preparing an oil phase by mixing molten lambda-cyhalothrin with N,N-dimethyldecanamide followed by addition of one or more capsule forming agent(s);
   b) preparing an aqueous phase by adding one or more inactive excipient(s) in demineralised water and mixing for about 15 minutes to about 60 minutes;
   c) charging the oil phase into the aqueous phase at an elevated temperature and mixing to form an emulsion;
   d) quenching the emulsion with an aqueous ammonia solution;
   e) maintaining the emulsion under stirring for a time period of about 30 minutes to 5 hours;
   f) adjusting the pH in the range of 4.5 to 6.5 and cooling the emulsion to room temperature to obtain microencapsulated Lambda-cyhalothrin;
ii) preparing emamectin benzoate and fipronil combination suspension concentrates (SC) comprising steps of:
   a) adding one or more inactive excipient(s) in demineralised water and mixing for about 15 minutes to about 60 minutes to form a mixture;
   b) adding emamectin benzoate, fipronil to the mixture and continuing to mix to obtain a slurry.
   c) passing the slurry through a mill for particle size reduction to obtain a homogeneous suspension concentrate (SC);
iii) preparing ZC formulation comprising steps of:
   a) mixing the microencapsulated lambda-cyhalothrin and the suspension concentrate of emamectin benzoate and fipronil combination along with a super spreader for about 15 minutes to 90 minutes to form a homogeneous mixture; and
   b) adding rheology modifier to the obtained homogeneous mixture and continuing to mix for about 3 hours to about 7 hours to obtain a ZC formulation (ZC).

In yet another aspect, the present disclosure provides a process for preparing a water-dispersible granule (WDG) comprising emamectin benzoate, fipronil and lambda-cyhalothrin.

In one specific aspect, the process for preparing water-dispersible granule (WDG) formulation comprising emamectin benzoate, fipronil and lambda-cyhalothrin comprises the steps of:
a) mixing lambda-cyhalothrin with one or more excipient(s) for about 15 minutes to about 60 minutes to obtain a lambda-cyhalothrin solution;
b) mixing fipronil and emamectin benzoate with one or more excipient(s) for about 30 minutes to about 4 hours to obtain a pre-blended powder;
c) grinding the pre-blended mixture through a mill to obtain a milled powder of desirable particle size of d(90)<12 microns;
d) homogenising the milled powder with desirable particle size for about 1 hour to about 4 hours to obtain a homogeneous powder,
e) adding the lambda-cyhalothrin solution to the homogeneous powder and mixing to prepare a uniform dough; and
f) extruding the uniform dough through an extruder to obtain extruded granules and drying the extruded granules in a dryer to obtain the water dispersible granule (WDG) formulation.

Various objects, features, aspects and advantages of the inventive subject matter will become more apparent from the following detailed description of preferred embodiments.

### DETAILED DESCRIPTION OF THE INVENTION

The following is a detailed description of embodiments of the present disclosure. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Unless the context requires otherwise, throughout the specification which follow, the word “comprise” and variations thereof, such as, “comprises” and “comprising” are to be construed in an open, inclusive sense that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

In some embodiments, the numbers expressing quantities of ingredients, properties such as concentration, process conditions, and so forth, used to describe and claim certain embodiments of the invention are to be understood as being modified in some instances by the term “about.” Accordingly, in some embodiments, the numerical parameters set forth in the written description are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The recitation of ranges of values herein is merely intended to serve as a shorthand method of referring individually to each separate value falling within the range. Unless otherwise indicated herein, each individual value is incorporated into the specification as if it were individually recited herein.

All methods described herein is performed in suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

The headings and abstract of the invention provided herein are for convenience only and do not interpret the scope or meaning of the embodiments.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The present invention does not use any ‘biological materials’ that is the materials which are capable of reproducing itself or being reproduced in a biological system.

The present disclosure provides an insecticide composition comprising emamectin benzoate, fipronil and lambda-cyhalothrin.

According to certain embodiments of the present disclosure, the insecticide composition comprising emamectin benzoate, fipronil and lambda-cyhalothrin can be provided as formulation.

The present disclosure provides an insecticide formulation comprising emamectin benzoate, fipronil and lambda-cyhalothrin.

Emamectin benzoate chemically known as (4″R)-4″-deoxy-4″-(methylamino)avermectin B1 benzoate (1:1) is an avermectin insecticide. It is a contact insecticide with negligible toxicity to non-target organisms. It allosterically activates glutamate-gated chloride channels (GluCls) causing paralysis in the insects.

Fipronil chemically known as 5-amino-1-[2,6-dichloro-4-(trifluoromethyl)phenyl]-4-[(trifluoromethyl)sulfinyl]-1H-pyrazole-3-carbonitrile is a phenylpyrazole insecticide. It is a systemic insecticide and it acts by blocking GABA-gated chloride channels in the central nervous system preventing the uptake of chloride ions resulting in excess neuronal stimulation and death of the target insects.

Lambda-cyhalothrin chemically known as (R)-cyano(3-phenoxyphenyl)methyl (1S,3S)-rel-3-[(1Z)-2-chloro-3,3,3-trifluoro-1-propen-1-yl]-2,2-dimethylcyclopropanecarboxylate is a pyrethroid ester insecticide. It is a contact insecticide and it acts by disrupting the gating mechanism of sodium channels that are involved in the generation and conduction of nerve impulses, causing rapid paralysis and death of the insects.

In certain embodiments, the insecticide composition and formulation comprises emamectin benzoate, fipronil and lambda-cyhalothrin in total amount ranging from about 0.1% to about 80% by weight of the composition or formulation.

In certain embodiments, the insecticide composition comprises, by weight, from about 0.1% to about 20% w/w of emamectin benzoate, from about 0.1% to about 40% w/w of fipronil and from about 0.1% to about 30.0% w/w of lambda-cyhalothrin.

In certain embodiments, the insecticide formulation comprises, by weight, from about 0.1% to about 20% w/w of emamectin benzoate, from about 0.1% to about 40% w/w of fipronil and from about 0.1% to about 30.0% w/w of lambda-cyhalothrin.

In various embodiments, the insecticide formulation comprising the combination of emamectin benzoate, fipronil and lambda-cyhalothrin can be provided in liquid or solid form.

In an embodiment, the solid or liquid formulation comprising active ingredient emamectin benzoate, fipronil and lambda-cyhalothrin is combined with one or more inactive excipients.

The inactive excipient is agrochemically acceptable excipient.

Suitable excipients will depend upon such factors as the type of formulation and the manner of the end use of the formulation, and will be known to a person skilled in the art.

In some embodiments, the inactive excipients can be selected from the group comprising of but not limiting to a pH stabilizer, an emulsifier, a dispersing agent, stabilizing agent, wetting agent, spreading agent, anti-foaming agent, rheology modifier, solvent, capsule forming agent, quenching agent, super spreader, an anti-freezing agent, a biocide, an anti-caking agent, inert carrier or combination thereof.

In an embodiment, the pH stabilizer can be selected from sodium silicate, potassium silicate, magnesium silicate, manganese silicate, sodium pyrophosphate, sodium acetate, sodium oxalate, sodium carbonate, sodium bicarbonate, sodium bentonite, sodium acetate, attapulgite, diatomaceous earth, sodium zeolite, trisodium phosphate, trisodium citrate, magnesium carbonate, magnesium sulphate, monoethanol amine, triethanol amine, triethylamine, dibasic esters selected from dimethyl succinate, dimethyl glutarate, dimethyl adipate, hydrochloric acid, oxalic acid, ortho phosphoric acid, citric acid anhydrous or mixtures thereof.

The pH stabilizer can be present in an amount ranging from about 0.01% to about 10% w/w of the composition or formulation.

Suitable emulsifier for use in the formulation includes all substances which normally can be used for this purpose in agrochemical formulations. Examples of the excipient include substances which can be ionic or non-ionic emulsifier or surfactant. The ionic substances can be selected from cationic emulsifier, or anionic emulsifier or combination thereof.

The ionic emulsifier or surfactant can be selected from the group comprising of but not limiting to calcium salt of alkylaryl sulfonates, ethoxylated and/or propoxylated di- or tri-styrylphenol phosphate, ethoxylated and/or propoxylated di- or tri-styrylphenol sulfate, phenyl sulfonate, alkynaphtalenesulphonate ethoxylated and/or propoxylated alcohol phosphate ester, ethoxylated and/or propoxylated alkylaryl phosphate ester, suphosuccinate, salts of polyacrylic acids, salts of lignosulphonic acid, salts of phenylsulphonic or naphthalenesulphonic acids, polycondensates of ethylene oxide with fatty alcohols or with fatty acids or with fatty amines, substituted phenols, especially alkylphenols, sulphosuccinic ester salts, and phosphoric esters of polyethoxylated phenols or alcohols or polycarboxylate, calcium dodecylbenzene sulfonate or mixtures thereof.

The non-ionic emulsifier or surfactant can be selected from the group comprising of but not limiting to alkoxylated alcohols, ethoxylated alcohols, ethoxylated propoxylated alcohols, alkylphenolethoxylates, alkoxylated tristyrylphenols, tristyryphenol ethoxylate, alkoxylated tributylphenols, alkylaminethoxylates, ethoxylated propoxylated polyaryl phenol, ethoxylated poly adducts of ethylene oxide and propylene oxide, ethoxylated fatty acids, sorbitan esters and their ethoxylates, sorbitol esters, propylene glycol esters of fatty acids and polyglycerol esters, ethoxylated ricinoleic acid triglycerides, castor oil ethoxylate or mixtures thereof.

The emulsifier can be present in an amount ranging from about 0.1% to about 20% w/w of the composition or formulation.

The dispersing agent can be selected, without limitation, from lignosulphonates, phenyl naphthalene sulphonates, ethoxylated alkyl phenols, ethoxylated fatty acids, alkoxylated linear alcohols, polyaromatic sulfonates, sodium alkyl aryl sulfonates, maleic anhydride copolymers, phosphate esters, condensation products of aryl/alkyl sulphonic acids and formaldehyde, addition products of ethylene oxide and fatty acid esters, sulfonates of condensed naphthalene, lignin derivatives, naphthalene formaldehyde condensates, polycarboxylates, sodium alkyl benzene sulfonates, alkali earth metal salt of alkylbenzene sulfonate, alkali earth metal salt of naphthalene formaldehyde condensate, calcium dodecylbenzene sulfonate, salts of sulfonated naphthalene, polystyrenated acrylated co-polymer, ammonium salts of sulfonated naphthalene, salts of polyacrylic acids, salts of phenol sulfonic acids, random co-polymer of alcoxylated polyethylene glycol, ethopropoxylated polyarylphenol phosphate amine salt, sodium lignosulfonate, polymethyl methacrylate-polyethylene glycol graft copolymer, polyalkoxylated butyl ether, sodium salt of naphthalene formaldehyde condensate or mixtures thereof.

The dispersing agent can be present in an amount ranging from about 0.1% to about 15% w/w of the composition or formulation.

The stabilizing agent can be selected from modified hydrophobic silica, colloidal silica, precipitated silica, hydrophobic silica powder, dimethyldichlorosilane-treated fumed silica, gamma butyrolactone, butylated hydroxyl toluene and its derivatives, epichlorhydrin, quinone derivatives, hydrazine hydrates and its derivatives, glycols or its derivatives, polyvinylpyrrolidone (PVP) or mixtures thereof.

The stabilizing agent can be present in an amount ranging from about 0.01% to about 10% w/w composition or formulation.

The wetting agent can be selected, without limitation, from alkyl phenol ethoxylate, fatty oil ethoxylate, phenyl naphthalene sulphonates, alkyl naphthalene sulfonates, sodium alkyl naphthalene sulfonate, sodium salt of sulfonated alkyl carboxylate, polyoxyalkylated ethyl phenols, polyoxyethoxylated fatty alcohols, polyoxyethoxylated fatty amines, lignin derivatives, alkane sulfonates, alpha olefin sulfonates, alkylbenzene sulfonates, salts of polycarboxylic acids, salts of esters of sulfosuccinic acid, octyl phenol ether sulphate, anionic phosphate esters, disodium laureth sulfosuccinate, diisodecyl sodium sulfosuccinate, alkylnaphthalenesulfonates, alkylbenzenesulfonates, alkylpolyglycol ether sulfonates, alkyl ether phosphates, alkyl ether sulfates and alkyl sulfosuccinic monoesters, dioctyl sulfosuccinate sodium salt, C₁₂₋₁₅ ethoxylated alcohols, C₁₂₋₁₅ alcohol ethoxylate (Atlox 4894), disodium hexadecyl sulphate or mixtures thereof.

The wetting agent can be present in an amount ranging from about 0.1% to about 15% w/w of the composition or formulation.

Suitable spreading agents can be selected from the group comprising of polyoxyethylene alkyl ether, trisiloxane ethoxylate, polysorbates, ethoxylated tristyrylphenol phosphate, sodium lauryl sulphate, sodium methyl oleoyl taurate, tridecyl alcohol ethoxylate or mixtures thereof.

The spreading agents can be present in an amount ranging from about 0% to about 10% w/w of the composition or formulation.

The anti-foaming agents can be selected from the group comprising perfluroalkylphosphonic acids, polydimethyl siloxane or mixtures thereof.

The anti-foaming agent can be present in an amount ranging from about 0.01% to about 5% w/w of the composition or formulation.

The rheology modifier can be selected from bentonite, diatomaceous earth, montmorillonite, attapulgites or hydroxymethyl cellulose, xanthan gum, polyvinyl alcohol, benton, thickening silica, hydrated clay minerals, magnesium aluminium silicates, polysaccharide gel, hydrophobic fumed silica, organic derivative of hectorite clay or mixtures thereof.

The rheology modifier can be present in an amount ranging from about 0.01% to about 10% w/w of the composition or formulation.

Suitable solvents for use in the formulation can be selected from all customary organic solvents which dissolve one or more of the active ingredients of the insecticide formulation. Suitable aqueous and non aqueous organic solvents for the compounds emamectin benzoate, fipronil and lambda-cyhalothrin are known in the art. Preferred solvents can be selected from but not limiting to, deionized (DI) water, demineralised water, oil medium selected from the group comprising, esterified fatty acids selected from methyl ester of triglycerides containing C₁₂-C₂₂ saturated and unsaturated fatty acids, ethyl ester of triglycerides containing C₁₂-C₂₂ saturated and unsaturated fatty acids such as methyl soyate (UNITOP-MSO), ethyl soyate, rapeseed methyl ester, rapeseed ethyl ester, Rhodiasolv® Adma 10 (N,N-Dimethyldecanamide), Rhodiasolv® match 111(blend of solvents), Rhodiasolve Green 25 (diisobutyl ester), Rhodiasolv® polar clean (5-(dimethylamino)-2-methyl-5-oxopentanoate) or mixtures thereof.

The solvent can be present in an amount ranging from about 0.01% to about 90% w/w of the composition or formulation.

The capsule forming agent can be selected from the group comprising of methylene diisocyanate, toluene diisocyanate or mixtures thereof.

The capsule forming agent can be present in an amount ranging from about 0.01% to about 5% w/w of the composition or formulation.

The quenching agent can be selected from the group comprising of ammonia solution (25%), ethylene diamine (EDA), ethanol-amine, butadiene or mixture thereof.

The quenching agent can be present in an amount ranging from about 0.01% to about 10% w/w of the composition or formulation.

Suitable super spreader can be selected from the group comprising of trisiloxane alkoxylate, modified trisiloxane or mixture thereof.

The super spreader can be present in an amount ranging from about 0% to about 10% w/w of the composition or formulation.

Suitable anti-freezing agents include ethylene glycol, glycerine, urea, propylene glycol or mixtures thereof.

The anti-freezing agent can be present in an amount from about 0.01% to about 15% w/w of the composition or formulation.

The biocide is selected from formaldehyde or 1,2-benzisothiazolin-3-one.

The biocide is present in an amount of from about 0.01% to about 5% w/w of the composition or formulation.

The anti-caking agent can be selected from kaolin clay, precipitate silica, colloidal silica, talc, gypsum, silicates, calcium carbonate, magnesium carbonate, magnesium sulfate, hydrophobic fumed silica or mixtures thereof.

The anti-caking agent can be present in an amount ranging from about 0.01% to about 10% w/w of the composition or formulation.

The inert carriers can be selected from kaolin, china clay, alumina, talc, chalk, quartz, attapulgite, montmorillonite, crushed and fractionated natural minerals such as calcite, marble, pumice, precipitated silica, sepiolite, bentonite, river sand, zeolites, starch, sand, talc, quartz, dolomite, diatomaceous earth or synthetic ground minerals such as highly dispersed silicic acid, aluminium oxide, corn starch, silicates, calcium phosphates, calcium hydrogen phosphates or mixtures thereof.

The inert carrier can be present in an amount ranging from about 1% to about 90% w/w of the composition or formulation.

In one specific embodiment the composition comprises emamectin benzoate in an amount of from 0.1% to 20% w/w, fipronil in an amount of from 0.1% to 40% w/w and lambda-cyhalothrin in an amount of from 0.1% to 30% w/w, a pH stabilizer in an amount of from 0.01% to 10% w/w, an emulsifier in an amount of from 0.1% to 20% w/w, a dispersing agent in an amount of from 0.1% to 15% w/w, stabilizing agent in an amount of from 0.01% to 10% w/w, wetting agent in an amount of from 0.1% to 15% w/w, spreading agent in an amount of from 0% to 10% w/w, anti-foaming agent in an amount of from 0.01% to 5% w/w, rheology modifier in an amount of from 0.01% to 10% w/w, solvent in an amount of from 0.01% to 90% w/w, capsule forming agent in an amount of from 0.01% to 5% w/w, quenching agent in an amount of from 0.01% to 10% w/w, super spreader in an amount of from 0% to 10% w/w, an anti-freezing agent in an amount of from 0.01 to 15% w/w, a biocide in an amount of from 0.01 to 5% w/w, an anti-caking agent in an amount of from 0.01% to 10% w/w or an inert carrier in an amount of from 1% to 90% w/w.

In another specific embodiment, the formulation comprises emamectin benzoate in an amount of from 0.1% to 20% w/w, fipronil in an amount of from 0.1% to 40% w/w and lambda-cyhalothrin in an amount of from 0.1% to 30% w/w, a pH stabilizer in an amount of from 0.01% to 10% w/w, an emulsifier in an amount of from 0.1% to 20% w/w, a dispersing agent in an amount of from 0.1% to 15% w/w, stabilizing agent in an amount of from 0.01% to 10% w/w, wetting agent in an amount of from 0.1% to 15% w/w, spreading agent in an amount of from 0% to 10% w/w, anti-foaming agent in an amount of from 0.01% to 5% w/w, rheology modifier in an amount of from 0.01% to 10% w/w, solvent in an amount of from 0.01% to 90% w/w, capsule forming agent in an amount of from 0.01% to 5% w/w, quenching agent in an amount of from 0.01% to 10% w/w, super spreader in an amount of from 0% to 10% w/w, an anti-freezing agent in an amount of from 0.01 to 15% w/w, a biocide in an amount of from 0.01 to 5% w/w, an anti-caking agent in an amount of from 0.01% to 10% w/w or an inert carrier in an amount of from 1% to 90% w/w.

In certain embodiments, the disclosed insecticide formulation is an oil-dispersion (OD), ZC formulation (ZC), water-dispersible granule (WDG), a water-soluble granule (SG), a wettable powder (WP), a water-dispersible powder (WDP), a water-soluble powder (SP), a granule (GR), an encapsulated granule (CG), a fine granule (FG), a macrogranule (GG), a microgranule (MG), a suspension concentrate (SC), a water-soluble concentrate (SL), a flowable suspension (FS), soil applied granules (SAG), dustable powder (DP), a gel, a water-dispersible tablet (WT), a dispersible concentrate (DC) or a microencapsulated suspension (CS).

In a preferred embodiment, the insecticide formulation comprising the combination of emamectin benzoate, fipronil and lambda-cyhalothrin is oil-dispersion (OD).

In one aspect, the oil-dispersion (OD) formulation comprises:
a) about 0.1% to about 20.0% emamectin benzoate by weight of the formulation
b) about 0.1% to about 40.0% fipronil by weight of the formulation;
c) about 0.1% to about 30.0% lambda-cyhalothrin by weight of the formulation;
d) about 0.01% to about 10.0% pH stabilizer by weight of the formulation;
e) about 0.1% to about 20.0% emulsifier by weight of the formulation;
f) about 0.1% to about 15.0% dispersing agent by weight of the formulation;
g) about 0.01% to about 10.0% stabilizing agent by weight of the formulation;
h) about 0.1% to about 15.0% wetting agent by weight of the formulation;
i) about 0% to about 10.0% spreading agent by weight of the formulation;
j) about 0.01% to about 5.0% antifoaming agent by weight of the formulation;
k) about 0.01% to about 10.0% rheology modifier by weight of the formulation; and
l) about 0.01% to about 90.0% solvent by weight of the formulation.

In one aspect, the oil-dispersion (OD) formulation comprises:
a) about 0.1% to about 20.0% emamectin benzoate by weight of the formulation;
b) about 0.1% to about 40.0% fipronil by weight of the formulation;
c) about 0.1% to about 30.0% lambda-cyhalothrin by weight of the formulation;
d) about 0.01% to about 10.0% pH stabilizer by weight of the formulation selected from the group comprising of sodium acetate, trisodium phosphate, trisodium citrate, oxalic acid, citric acid anhydrous or mixture thereof;
e) about 0.1% to about 20.0% emulsifier by weight of the formulation selected from the group comprising of ethoxylated propoxylated alcohols, alkylphenolethoxylates, alkoxylated tristyrylphenols, ethoxylated propoxylated polyaryl phenol, ethoxylated fatty acids, ethoxylated ricinoleic acid triglycerides, castor oil ethoxylate or mixtures thereof;
f) about 0.1% to about 15.0% dispersing agent by weight of the formulation selected from the group comprising of naphthalene formaldehyde condensates, polycarboxylates, calcium dodecylbenzene sulfonate, polystyrenated acrylated co-polymer, salts of phenol sulfonic acids, random co-polymer of alcoxylated polyethylene glycol or mixtures thereof;
g) about 0.01% to about 10.0% stabilizing agent by weight of the formulation selected from the group comprising of precipitated silica, polyvinylpyrrolidone (PVP) or mixtures thereof;
h) about 0.1% to about 15.0% wetting agent by weight of the formulation selected from the group comprising of sodium alkyl naphthalene sulfonate, alpha olefin sulfonates, disodium laureth sulfosuccinate, diisodecyl sodium sulfosuccinate, alkyl sulfosuccinic monoesters, dioctyl sulfosuccinate sodium salt or mixtures thereof;
i) about 0% to about 10.0% spreading agent by weight of the formulation selected from the group comprising of polyoxyethylene alkyl ether, trisiloxane ethoxylate, polysorbates, sodium lauryl sulphate, tridecyl alcohol ethoxylate or mixtures thereof;
j) about 0.01% to about 5.0% antifoaming agent by weight of the formulation selected from the group comprising perfluroalkylphosphonic acids, polydimethyl siloxane or mixtures thereof;
k) about 0.01% to about 10.0% rheology modifier by weight of the formulation selected from the group comprising of fume silica, bentonite, hydroxymethyl cellulose, xanthan gum, thickening silica, hydrated clay minerals, magnesium aluminium silicates, organic derivative of hectorite clay, hydrophobic fumed silica or mixture thereof; and
l) about 0.01% to about 90.0% solvent by weight of the formulation selected from the group comprising of oil medium selected from the group comprising, esterified fatty acids selected from methyl ester of triglycerides containing C₁₂-C₂₂ saturated and unsaturated fatty acids, ethyl ester of triglycerides containing C₁₂-C₂₂ saturated and unsaturated fatty acids such as methyl soyate, ethyl soyate, rapeseed methyl ester, rapeseed ethyl ester or mixtures thereof.

In another aspect, the present disclosure provides a process for preparing oil-dispersion (OD) formulation comprising the steps of:
a) mixing one or more excipients along with an oil medium to obtain a mixture;
b) adding emamectin benzoate, fipronil and lambda-cyhalothrin to the mixture and continuing to mix to obtain a slurry;
c) passing the slurry through a mill for particle size reduction to obtain a milled slurry; and
d) adding a rheology modifier to the milled slurry and continuing to mix to obtain a homogeneous oil dispersion (OD).

In one embodiment, the mill for particle size reduction is a jacketed mill with chilled water circulation.

In one embodiment, the inactive excipients are selected from the group comprising of a pH stabilizer, an emulsifier, a dispersing agent, stabilizing agent, wetting agent, spreading agent, anti-foaming agent, rheology modifier, solvent or combination thereof.

In a preferred embodiment, the insecticide formulation comprising the combination of emamectin benzoate, fipronil and lambda-cyhalothrin is a ZC formulation (ZC).

In one aspect, the ZC formulation (ZC) formulation comprises:
a) about 0.1% to about 20.0% emamectin benzoate by weight of the formulation;
b) about 0.1% to about 40.0% fipronil by weight of the formulation;
c) about 0.1% to about 30.0% lambda-cyhalothrin by weight of the formulation;
d) about 0.01% to about 90.0% solvent by weight of the formulation;
e) about 0.01% to about 5% capsule forming agent by weight of the formulation;
f) about 0.01% to about 10% quenching agent by weight of the formulation;
g) about 0% to about 10% super spreader by weight of the formulation;
h) about 0.1% to about 20.0% emulsifier by weight of the formulation;
i) about 0.1% to about 15.0% dispersing agent by weight of the formulation;
j) about 0.1% to about 15.0% wetting agent by weight of the formulation;
k) about 0.01% to about 15.0% anti-freezing agent by weight of the formulation;
l) about 0.01 to about 5% biocide by weight of the formulation;
m) about 0.01% to about 5.0% antifoaming agent by weight of the formulation;
n) about 0.01% to about 10.0% pH stabilizer by weight of the formulation; and
o) about 0.01% to about 10.0% rheology modifier by weight of the formulation.

In another aspect, the ZC formulation (ZC) formulation comprises:
a) about 0.1% to about 20.0% emamectin benzoate by weight of the formulation;
b) about 0.1% to about 40.0% fipronil by weight of the formulation;
c) about 0.1% to about 30.0% lambda-cyhalothrin by weight of the formulation;
d) about 0.01% to about 90.0% solvent by weight of the formulation selected from the group comprising of deionized (DI) water, demineralised water, N,N-dimethyldecanamide, or mixtures thereof;
e) about 0.01% to about 5% capsule forming agent by weight of the formulation selected from the group comprising of methylene diisocyanate, toluene diisocyanate or mixtures thereof;
f) about 0.01% to about 10% quenching agent by weight of the formulation selected from the group comprising of ethylene diamine (EDA), ethanol-amine, butadiene, ammonia solution (25%) or mixture thereof;
g) about 0% to about 10% super spreader by weight of the formulation selected from the group comprising of trisiloxane alkoxylate, modified trisiloxane or mixture thereof;
h) about 0.1% to about 20.0% emulsifier by weight of the formulation selected from the group comprising of ethoxylated or propoxylated alkylaryl phosphate ester, polycondensates of ethylene oxide with fatty alcohols ethoxylated alcohols, alkylphenolethoxylates, alkoxylated tristyrylphenols, calcium dodecylbenzene sulfonate or mixture thereof;
i) about 0.1% to about 15.0% dispersing agent by weight of the formulation selected from the group comprising of naphthalene formaldehyde condensates, polycarboxylates, polystyrenated acrylated co-polymer, ethopropoxylated polyarylphenol phosphate amine salt, sodium lignosulfonate, polymethyl methacrylate-polyethylene glycol graft copolymer or mixture thereof;
j) about 0.1% to about 15.0% wetting agent by weight of the formulation selected from the group comprising of alkyl naphthalene sulfonates, dioctyl sulfosuccinate sodium salt, alpha olefin sulfonates, alkyl ether sulphates, C₁₂₋₁₅ alcohol ethoxylate or mixture thereof;
k) about 0.01% to about 15.0% anti-freezing agent by weight of the formulation selected from the group comprising of ethylene glycol, glycerine, urea, propylene glycol or mixture thereof;
l) about 0.01 to about 5% biocide by weight of the formulation selected from the group comprising of formaldehyde, 1,2-benzisothiazolin-3-one or mixtures thereof;
m) about 0.01% to about 5.0% antifoaming agent by weight of the formulation selected from the group comprising of perfluroalkylphosphonic acids, polydimethyl siloxane or mixture thereof;
n) about 0.01% to about 10.0% pH stabilizer by weight of the formulation selected from the group comprising of sodium pyrophosphate, sodium acetate, sodium acetate, trisodium phosphate, trisodium citrate, triethanol amine, citric acid anhydrous, ortho phosphoric acid or mixture thereof; and
o) about 0.01% to about 10.0% rheology modifier by weight of the formulation selected from the group comprising of hydrophobic fumed silica, bentonite, xanthan gum, polysaccharide gel or mixtures thereof.

In another embodiment, the present disclosure provides a process for preparing ZC formulation (ZC) comprising the steps of:
i) preparing microencapsulated Lambda-cyhalothrin (CS) comprising steps of:
   a) preparing an oil phase by mixing molten lambda-cyhalothrin with N,N-dimethyldecanamide followed by addition of one or more capsule forming agent(s);
   b) preparing an aqueous phase by adding one or more inactive excipient(s) in demineralised water and mixing for about 15 minutes to about 60 minutes;
   c) charging the oil phase into the aqueous phase at an elevated temperature and mixing to form an emulsion;
   d) quenching the emulsion with an aqueous ammonia solution;
   e) maintaining the emulsion under stirring for a time period of about 30 minutes to 5 hours;
   f) adjusting the pH in the range of 4.5 to 6.5 and cooling the emulsion to room temperature to obtain microencapsulated Lambda-cyhalothrin;
ii) preparing emamectin benzoate and fipronil combination suspension concentrates (SC) comprising steps of:
   a) adding one or more inactive excipient(s) in demineralised water and mixing for about 15 minutes to about 60 minutes to form a mixture;
   b) adding emamectin benzoate, fipronil to the mixture and continuing to mix to obtain a slurry.
   c) passing the slurry through a mill for particle size reduction to obtain a homogeneous suspension concentrate (SC);
iii) preparing ZC formulation comprising steps of:
   a) mixing the microencapsulated lambda-cyhalothrin and the suspension concentrate of emamectin benzoate and fipronil combination along with a super spreader for about 15 minutes to 90 minutes to form a homogeneous mixture; and
   b) adding rheology modifier to the obtained homogeneous mixture and continuing to mix for about 3 hours to about 7 hours to obtain a ZC formulation (ZC).

In an embodiment, the mixing of the oil phase with the aqueous phase is carried out using a high shear mixer.

In one embodiment, the mill for particle size reduction is a wet mill.

In another embodiment, the inactive excipients are selected from the group comprising of a solvent, capsule forming agent, quenching agent, super spreader, an emulsifier, a dispersing agent, wetting agent, an anti-freezing agent, a biocide, anti-foaming agent, a pH stabilizer, rheology modifier or combination thereof.

In another preferred embodiment, the insecticide formulation comprising the combination of emamectin benzoate, fipronil and lambda-cyhalothrin is a water-dispersible granule (WDG) formulation.

In one aspect, the water-dispersible granule (WDG) formulation. comprises:
a) about 0.1% to about 20.0% emamectin benzoate by weight of the formulation;
b) about 0.1% to about 40.0% fipronil by weight of the formulation;
c) about 0.1% to about 30.0% lambda-cyhalothrin by weight of the formulation;
d) about 0.1% to about 20.0% emulsifier by weight of the formulation;
e) about 0.1% to about 15.0% dispersing agent by weight of the formulation;
f) about 0.01% to about 10.0% pH stabilizer by weight of the formulation;
g) about 0.1% to about 15.0% wetting agent by weight of the formulation;
h) about 0.01% to about 5.0% antifoaming agent by weight of the formulation;
i) about 0.01% to about 10.0% anti-caking agent by weight of the formulation;
j) about 0.01% to about 90.0% solvent by weight of the formulation; and
k) about 1% to about 90.0% inert carrier by weight of the formulation.

In another aspect, the water-dispersible granule (WDG) formulation. comprises:
a) about 0.1% to about 20.0% emamectin benzoate by weight of the formulation;
b) about 0.1% to about 40.0% fipronil by weight of the formulation;
c) about 0.1% to about 30.0% lambda-cyhalothrin by weight of the formulation;
d) about 0.1% to about 20.0% emulsifier by weight of the formulation selected from the group comprising of calcium dodecylbenzene sulfonate, alkoxylated alcohols, tristyryphenol ethoxylate, ethoxylated fatty acids, ethoxylated ricinoleic acid triglycerides, castor oil ethoxylate or mixtures thereof;
e) about 0.1% to about 15.0% dispersing agent by weight of the formulation selected from the group comprising of lignosulphonates, polycarboxylates, calcium dodecylbenzene sulfonate, polymethyl methacrylate-polyethylene glycol graft copolymer, polyalkoxylated butyl ether, sodium salt of naphthalene formaldehyde condensate or mixtures thereof;
f) about 0.01% to about 10.0% pH stabilizer by weight of the formulation selected from the group comprising of sodium acetate, trisodium phosphate, trisodium citrate, ortho phosphoric acid, oxalic acid, citric acid anhydrous or mixtures thereof;
g) about 0.1% to about 15.0% wetting agent by weight of the formulation selected from the group comprising of alkyl naphthalene sulfonates, dioctyl sulfosuccinate sodium salt, alkyl ether sulphates, disodium hexadecyl sulphate or mixtures thereof;
h) about 0.01% to about 5.0% antifoaming agent by weight of the formulation selected from the group comprising of perfluroalkylphosphonic acids, polydimethyl siloxane or mixture thereof;
i) about 0.01% to about 10.0% anti-caking agent by weight of the formulation selected from the group comprising of precipitate silica, hydrophobic fumed silica or mixtures thereof;
j) about 0.01% to about 90.0% solvent by weight of the formulation selected from the group comprising of deionized (DI) water, diisobutyl ester, 5-(dimethylamino)-2-methyl-5-oxopentanoate, N,N-dimethyldecanamide or mixtures thereof; and
k) about 1% to about 90.0% inert carrier by weight of the formulation selected from the group comprising of kaolin, china clay, precipitated silica, bentonite, corn starch or mixtures thereof.

In another aspect, the process for preparing water-dispersible granule (WDG) formulation comprises the steps of:
a) mixing lambda-cyhalothrin with one or more excipients for about 15 minutes to about 60 minutes to obtain a lambda-cyhalothrin solution;
b) mixing fipronil and emamectin benzoate with one or more excipients for about 30 minutes to about 4 hours to obtain a pre-blended powder;
c) grinding the pre-blended mixture through a mill to obtain a milled powder of desirable particle size of d(90)<12 microns;
d) homogenising the milled powder with desirable particle size for about 1 hour to about 4 hours to obtain a homogeneous powder,
e) adding the lambda-cyhalothrin solution to the homogeneous powder and mixing to prepare a uniform dough; and
f) extruding the uniform dough through an extruder to obtain extruded granules and drying the extruded granules in a dryer to obtain the water dispersible granule (WDG) formulation.

In one embodiment, the extruder for extruding the uniform dough is basket extruder.

In one embodiment, the dryer for drying the extruded granules is fluid bed drier.

In another embodiment, the inactive excipients are selected from the group comprising of an emulsifier, a dispersing agent, a pH stabilizer, wetting agent, anti-foaming agent, an anti-caking agent, solvent, an inert carrier or combination thereof.

The conventional formulations such as emulsifiable concentrate (EC) and water emulsion or emulsions in water (EW) known in the art are having disadvantage of containing toxic solvents such as xylene which is highly flammable, highly volatile, causes skin irritation and serious eye irritation in contact and may also damage organs through prolonged or repeated exposure and dichloromethane which is carcinogenic, highly volatile and also causes skin irritation, serious eye irritation and drowsiness or dizziness in contact and may also damage organs through prolonged or repeated exposure. In contrast, the formulations of the present invention such as the oil dispersion (OD), ZC formulation and water dispersible granule (WDG) formulations of the present invention are environmentally safe, as the formulation does not involve the usage of such highly flammable, highly volatile and carcinogenic organic solvents. In addition, the formulations of the present invention include one or more of advantages such as a reduction in application rate of individual active ingredients, a faster onset of insecticidal action, a longer-lasting action, better control of broad spectrum of insects with only one or a few applications, and a broadening of possible application period. It was an unexpected finding that the dose of each active ingredient markedly reduced, when all the three compounds are comprised in combination in a single formulation, while maintaining a high level of insecticidal efficacy.

The insecticide composition and formulation thereof according to the present disclosure can be advantageously applied for the protection of crops such as cotton, brinjal, okra, tomato, chilli, soybean, chick pea and cabbage.

In specific embodiments, the insecticide composition and formulation thereof in accordance with the present disclosure can be applied for protection of cotton and chilli crops.

The insecticide composition and formulation of the present invention can control the broad spectrum of insects of different orders that is order lepidoptera and order homoptera. The insecticide formulation of the present disclosure can control insects of order lepidoptera including caterpillars such as helicoverpa, spodoptera, pink bollworm; and of order homoptera which include sucking pests such as thrips, jassids, and aphids by one time application.

The insecticide composition and formulation of the present invention can be applied to the insects in a variety of ways, at various application timing and at various concentrations.

In one embodiment, the insecticide composition and formulation of the present disclosure is applied to the insects by foliar application. The application of the insecticide formulation is done on the crops from vegetative phase to reproductive phase. The total application rate of the formulation provided in accordance with the present disclosure comprising emamectin benzoate, fipronil and lambda-cyhalothrin vary over a wide range, for example from 1 to 500 g/ml per hectare (g/ml/ha).

In one embodiment, the formulation provided in accordance with the present disclosure can be applied at the application rate ranging from 450 to 500 g/ml per hectare (g/ml/ha).

The insecticide formulation thereof can be applied in a single treatment or in several treatments (sequential application).

### EXAMPLES

The present disclosure is further explained in the form of following examples. However, it is to be understood that the following examples are merely illustrative and are not to be taken as limiting to the invention. Various changes and modifications to the disclosed embodiments will be apparent to those skilled in the art. Such changes and modifications may be made without departing from the disclosure of the present application.

### Example 1

Oil-Dispersion (OD) Formulation in Accordance with the Present Invention

### I. Preparation of the OD Formulation

### 1. Composition

As per some specific exemplary embodiments, oil-dispersible (OD) formulations was prepared with combinations as per Table 1:

TABLE 1
Composition for oil-dispersion (OD) formulations
of the present invention.

| | Example 1 |
|---|---|
| Ingredients | % w/w |
| Emamectin benzoate | 2.20 |
| Fipronil | 10.0 |
| Lambda-cyhalothrin | 5.0 |
| Citric acid anhydrous | 0.50 |
| Tergitol ECO-36 | 5.0 |
| Random co-polymer of alcoxylated | 2.0 |
| polyethylene glycol | |
| Polyvinylpyrrolidone (PVP) | 0.5 |
| Dioctyl sulfosuccinate sodium salt | 5.0 |
| Tridecyl Alcohol ethoxylate | 5.0 |
| Polydimethyl siloxane | 0.5 |
| Hydrophobic fumed silica | 6.0 |
| Organic derivative of hectorite clay | 1.0 |
| Methyl soyate (UNITOP - MSO) | Q.S. |
| Total | 100.00 |

### 2. Process for Preparing the Oil-Dispersion (OD) Formulation

An oil medium methyl soyate (UNITOP-MSO) along with other constituents namely citric acid anhydrous, ethoxylated ricinoleic acid triglycerides (Tergitol ECO-36), random co-polymer of alcoxylated polyethylene glycol, polyvinylpyrrolidone (PVP), dioctylsulfosuccinate sodium salt, tridecylalcohol ethoxylate, and polydimethyl siloxane as mentioned in Example 1 were added into the clean pre mixing vessel fitted with the homogenizer and all the ingredients were mixed for 15 minutes with the homogenizer to obtain a mixture. The active ingredients, emamectin benzoate, fipronil and lambda-cyhalothrin were added to the obtained mixture and continued to mix for 1 to 2 hours with a homogenizer to obtain a slurry. The slurry was passed through a jacketed bead mill with chilled water circulation for particle size reduction to obtain a milled slurry of desirable particle size of d(90)<12 microns. The milled slurry was collected into post mixing vessel fitted with the stirrer. A rheology modifiers hydrophobic fumed silica and organic derivative of hectorite clay as mentioned in Table 1 were added into the post mixing vessel and continued to mix for 4 to 6 hours to obtain homogeneous oil dispersion (OD).

Without bound by any theory it, is believed methyl soyate (UNITOP-MSO) when used as a solvent, both the active ingredients that is lambda-cyhalothrin having a low melting point and fipronil having restricted solubility in suitable solvent remain stable; further, the methyl soyate (UNITOP-MSO) being an oil medium is believed to rupture the outer covering layer of the insects(insect cuticle) and help the active ingredients lambda-cyhalothrin, fipronil and emamectin benzoate to penetrate easily into the insect cuticle thereby improving the performance of the active ingredients; thus, methyl soyate (UNITOP-MSO) acts as both solvent in which active ingredients remain stable and as an integral adjuvant which helps in easy and fast penetration of active ingredients thereby avoiding the addition of external adjuvant before spraying the OD formulation of the present invention.

### II. Accelerated Storage Test (Stability Study)

According to the FAO/WHO manual, the “accelerated storage test” is considered as an indicative of product stability. That is accelerated storage test data provides an indication that the product is stable for at least two years at ambient temperature. Further, the FAO/WHO manual indicates storage at 54° C.±2° C. for 14 days as the default test conditions.

The “ambient sample” is the sample at the room temperature which is before subjecting to the accelerated storage tests at 54±2° C. for 14 days.

The “accelerated storage sample” is the sample after subjecting to the accelerated storage test.

The ambient samples of the oil dispersion (OD) formulation of the above Example 1 were subjected to the accelerated storage test to find out the product stability.

Table 2 shows the physical and chemical properties of the oil-dispersion (OD) formulation of Example 1 before and after the accelerated storage test.

TABLE 2
Physical and chemical properties of the OD formulation of
Example 1 before and after the accelerated storage test.

| | | Accelerated |
|---|---|---|
| | | Storage |
| | | Sample |
| | | Tested @ |
| | Ambient | 54 ± 2° C. |
| S. | Sample | For 14 Days |

| No. | Tests | | Product Specifications | (Before) | (After) |
|---|---|---|---|---|---|
| 1 | Appearance | | Off white to cream colour | Complies | Complies |
| | | | suspension | | |
| 2 | Active | Emamectin | Content: 2.09-2.42 | 2.20 | 2.13 (3.2%*) |
| | Ingredient/ | benzoate | | | |
| 3 | content | Fipronil | Content: 9.50-10.50 | 10.00 | 9.97 (0.3%*) |
| 4 | test % | Lambda | Content: 4.75-5.50 | 5.00 | 4.99 (0.2%*) |
| | w/w | cyhalothrin | | | |

| 5 | Persistent Foam, | Max. 60 | | 15 | 14 |
|---|---|---|---|---|---|
| | mL | | | | |
| 6 | Wet sieve passing | Min 98.0 | | 99.95 | 99.93 |
| | through 75 micron | | | | |
| | % w/w | | | | |
| 7 | pH of 1% aq. | 3.50-6.50 | | 4.80 | 14.76 |
| | dispersion | | | | |
| 8 | Dispersion stability | Time hr. | Limits of stability | | |
| | | 0 | Initial | Complies | Complies |
| | | | dispersion | | |
| | | | completed | | |
| | | 0.5 | No cream and | Nil | Nil |
| | | | no sedimentation | | |
| | | | seen after 0.5 | | |
| | | | hours | | |
| | | | (creaming and | | |
| | | | sedimentation | | |
| | | | should not be | | |
| | | | more than 2 ml | | |
| | | | in 100 ml | | |
| | | | dilution). | | |
| | | 24.0 | Re-dispersion | Complies | Complies |
| | | | completed | | |
| | | 24.5 | No cream and | Nil | Nil |
| | | | no sedimentation | | |
| | | | seen after 24.5 | | |
| | | | hours | | |
| | | | (creaming and | | |
| | | | sedimentation | | |
| | | | should not be | | |
| | | | more than 2 ml | | |
| | | | in 100 ml | | |
| | | | dilution). | | |

| | | | | |
|---|---|---|---|---|
| 9 | Particle size | Max. 12μ | 8.07 | 9.10 |
| | distribution, μ | | | |
| | d(90) | | | |
| 10 | Pourability % w/w | Max. 1.0 | 0.52 | 0.51 |
| | as rinse residue | | | |

Min. = Minimum
Max. = Maximum

The results in Table 2 show that the appearance of the ambient sample of the oil-dispersion (OD) formulation before and after the accelerated storage test (@54±2° C. for 14 days) remained the same that is ‘off white to cream colour suspension’.

Further, the content of emamectin benzoate, fipronil and lambda-cyhalothrin was found to be 2.20% w/w, 10.00% w/w, 5.00% w/w, respectively before subjecting the ambient sample to the accelerated storage test. After subjecting the ambient sample to the accelerated storage test the content of emamectin benzoate, fipronil and lambda-cyhalothrin was found to be the almost same, that is 2.13% w/w, 9.97% w/w, 4.99% w/w respectively. It indicates that the content of emamectin benzoate, fipronil and lambda-cyhalothrin was degraded only by 3.2%, 0.3% and 0.2% respectively and falls within the product specification range and hence the content of the active ingredients in the formulation is stable.

The pH of the ambient sample of the OD formulation before subjecting it to the accelerated storage test was found to be 4.80. However, even after subjecting the ambient sample to the accelerated storage test the pH was found to be almost same, that is 4.76. It indicates that the oil-dispersion was adhering to the pH range of 3.50-6.50 which indicates that the formulation is stable.

Dispersion stability test is performed to ensure that a sufficient proportion of active ingredient is homogeneously dispersed in the spray liquid to give a satisfactory and effective mixture throughout spraying. The ambient sample and accelerated storage sample of the oil-dispersion (OD) formulation, subjected to dispersion stability test did not show any cream or sedimentation even after 0.5 hours of the dispersion or 24.5 hours of the re-dispersion test.

Tests such as persistent foam and pourability were conducted for the ambient sample of the oil-dispersion (OD) formulation, before and after accelerated storage test. The results indicated that persistent foam test showed low persistent foam of 15 ml and 14 ml indicating the less froth formation and pourability test showed low rinse residue of 0.52% and 0.51% indicating less wastage of the formulation.

The ambient sample of the oil-dispersion (OD) formulation was diluted in water and was tested for its particle size by particle size distribution test by using laser diffraction method using Malvern MS3000 and wet sieve passing test by using 75μ wet sieve. The particle size distribution test showed that particle size distribution of the ambient sample was d(90) is 8.07p and the particle size distribution of the accelerated storage sample was found to be almost same that is d (90) is 9.10μ and wet sieve passing test showed passing of 99.95% w/w and 99.93% w/w of particles of the formulation through the 75μ wet sieve indicating the low particle size (9.10μ) of the formulation. Therefore, both the tests confirm the low particle size (9.10μ) and no crystal growth after the accelerated storage test.

The particle size distribution of the oil-dispersion (OD) is directly related to the efficacy, dispersion stability, and required dosage of the combination. That is the smaller particle size (9.10μ) of the oil-dispersion (OD) of the present invention provide better dispersion stability, since small particle sizes enable the Brownian motion to dominate over gravitational force, provides a larger specific surface area, which will further increase the dissolution rate, adhesion, and penetrability to the target pest, improving the efficacy and bioavailability of the formulation which leads to the increased insecticidal activity.

Thus, in all the tests, values of the tests remained almost same before and after accelerated storage test which indicates that the formulation is stable.

In view of the above test results, oil-dispersion (OD) formulation of the present invention prepared in accordance with the above examples are extrapolated to be stable for 2 years.

The advantages of the oil-dispersion (OD) formulations of the present invention include storage stability, excellent adherence to its target pest and easy penetration of active ingredients in the target pest, uniform spreading of spray solution over insects which leads to high absorption through insect cuticle, reduced sedimentation during storage, environmental friendly due to the usage of low cost and biodegradable solvents, simple production process saves production and equipment costs, simple and easy handling for the users as the dilution is made with the desired amount of water. Also, as the OD formulation is diluted in water, it forms a stable milky dispersion of fine particles size of from 0.1 to 12 microns which lead to the improved bio-efficacy.

### Example 2

ZC Formulation in Accordance with the Present Invention

### I. Preparation of the ZC Formulations

### 1. Composition

As per some specific exemplary embodiments ZC formulation (ZC) formulation was prepared with composition as per Table 3:

TABLE 3
Composition for ZC formulation (ZC) of the present invention.

| | Example 2 |
|---|---|
| Ingredients | % w/w |
| Emamectin benzoate | 2.20 |
| Fipronil | 10.0 |
| Lambda-cyhalothrin | 5.0 |
| N,N-Dimethyldecanamide | 5.0 |
| (Rhodiasolv ® Adma 10) | |
| Methylene diisocyanate | 0.4 |
| Toluene diisocyanate | 0.4 |
| Ammonia solution (25%) | 0.4 |
| Modified trisiloxane | 2.5 |
| Calcium dodecylbenzene sulfonate | 0.5 |
| Ethopropoxylated polyarylphenol | 0.5 |
| phosphate amine salt | |
| Sodium lignosulfonate | 1.0 |
| C₁₂-₁₅ alcohol ethoxylate (Atlox 4894) | 2.0 |
| Polymethyl methacrylate-polyethylene | 4.0 |
| glycol graft copolymer | |
| Propylene glycol | 5.0 |
| 1,2-benzisothiazolin-3-one | 0.1 |
| Polydimethyl siloxane | 0.5 |
| Ortho phosphoric acid (85%) | 0.8 |
| Polysaccharide Gel | 0.14 |
| Demineralised water | QS |
| Total | 100.00 |

### 2. Process for Preparing the ZC Formulations

### (a) Preparing Microencapsulated Lambda-Cyhalothrin (CS):

A molten lambda-cyhalothrin was dissolved in an N,N-dimethyldecanamide (Rhodiasolv® Adma 10) in a vessel fitted with stirrer and the capsule forming agents methylene diisocyanate and toluene diisocyanate were added to it as mentioned in Example 2 to prepare an oil phase. The calcium dodecylbenzene sulfonate, ethopropoxylated polyarylphenol phosphate amine salt, sodium lignosulfonate, polydimethyl siloxane, demineralised water as mentioned in Example 2 were added into the jacketed vessel with hot water circulation (50° C.-60° C.) fitted with homogenizer and all the ingredients were mixed in demineralised water for 30 minutes with the homogenizer to prepare an aqueous phase. The temperature of the jacketed vessel was then raised to 60° C. and the oil phase was slowly added to the aqueous phase, and mixed in a high shear mixture to form an emulsion of a median particle size between 5p and 10p and to initiate wall formation reaction. The emulsion thus obtained was treated with ammonia solution (25%) to quench any unreacted isocyanate present in the emulsion, and then stirred for a period of 2 hrs. The pH of the emulsion was adjusted to 4.5-6.5 using ortho phosphoric acid. And the emulsion was cooled to room temperature to obtain microencapsulated lambda-cyhalothrin.

### (b) Preparing Emamectin Benzoate and Fipronil Combination Suspension Concentrates (SC):

A propylene glycol, C₁₂₋₁₅ alcohol ethoxylate (Atlox 4894), polymethyl methacrylate-polyethylene glycol graft copolymer, 1,2-benzisothiazolin-3-one, demineralised water as mentioned in Example 2 were added into the dry mixing vessel fitted with stirrer and all the ingredients were mixed in demineralised water for 30 minutes with the stirrer to form a mixture. The active ingredients emamectin benzoate and fipronil were added to the mixture and continued to mix for 30 minutes to obtain a slurry. The slurry was passed through a wet mill for particle size reduction (d90<12 microns) to obtain a homogenous suspension concentrate (SC).

### (c) Preparing ZC Formulation:

The microencapsulated lambda-cyhalothrin and the suspension concentrate of emamectin benzoate and fipronil combination was charged into a clean and dry mixing vessel fitted with stirrer, the super spreader modified trisiloxane as mentioned in example 2 is added into it and mixed for about 60 minutes to form a homogeneous mixture. The rheology modifier, polysaccharide gel as mentioned in the example 2 was added to the homogeneous mixture and continued to mix for about 3 hours to about 7 hours to obtain a ZC formulation (ZC).

### II. Accelerated Storage Test (Stability Study)

According to the FAOWHO manual, the “accelerated storage test” is considered as an indicative of product stability. That is accelerated storage test data provides an indication that the product is stable for at least two years at ambient temperature. Further, the FAQ/WHO manual indicates storage at 54° C.±2° C. for 14 days as the default test conditions.

The “ambient sample” is the sample at the room temperature which is before subjecting to the accelerated storage tests at 54±2° C. for 14 days.

The “accelerated storage sample” is the sample after subjecting to the accelerated storage test.

The ambient samples of the ZC formulation (ZC) of the above Example 2 were subjected to the accelerated storage test to find out the product stability.

Table 4 shows the physical and chemical properties of the ZC formulation (ZC) of Example 2 before and after the accelerated storage test.

TABLE 4
Physical and chemical properties of the ZC formulation (ZC)
of Example 2 before and after the accelerated storage test.

| | | | | | Accelerated |
|---|---|---|---|---|---|
| | | | | | Storage Sample |
| | | | | Ambient | Tested @ 54 ± 2° C. |
| S. | | | Product | Sample | For 14 Days |
| No. | Tests | | Specifications | (Before) | (After) |
| 1 | Appearance | | Off white to | Complies | Complies |
| | | | cream colour | | |
| | | | suspension | | |
| 2 | Active | Emamectin | Content: | 2.20 | 2.13 (3.2%*) |
| | Ingredient/ | benzoate | 2.09-2.42 | | |
| 3 | content | Fipronil | Content: | 10.00 | 9.99 (0.1%*) |
| | test % w/w | | 9.50-10.50 | | |
| 4 | | Lambda | Content: | 5.00 | 4.98 (0.4%*) |
| | | cyhalothrin | 4.75-5.50 | | |
| 5 | Suspensibility | Emamectin | Min. 70 | 100.0 | 100.0 |
| | (% w/w) | benzoate | | | |
| 6 | | Fipronil | Min. 70 | 97.42 | 97.29 |
| 7 | | Lambda | Min. 70 | 95.90 | 95.76 |
| | | cyhalothrin | | | |

| | | | | |
|---|---|---|---|---|
| 8 | Spontaneity of | Min. 80 | 98.98 | 98.85 |
| | dispersion | | | |
| 9 | Wet sieve passing | Min 98.0 | 99.94 | 99.90 |
| | through 75 micron | | | |
| | test sieve (% w/w) | | | |
| 10 | Persistent Foam, mL | Max. 60 | 18 | 20 |
| 11 | pH of 1% aq. | 3.50-6.50 | 5.60 | 5.58 |
| | dispersion | | | |
| 12 | Pourability % w/w as | Max. 1.0 | 0.52 | 0.51 |
| | rinse residue | | | |

Min. = Minimum
Max. = Maximum

The results in Table 4 show that the appearance of the ambient sample of the ZC formulation before and after the accelerated storage test (@54±2° C. for 14 days) remained the same that is ‘off white to cream colour suspension’.

Further, the content of emamectin benzoate, fipronil and lambda-cyhalothrin was found to be 2.20% w/w, 10.00% w/w, 5.00% w/w, respectively before subjecting the ambient sample to the accelerated storage test. After subjecting the ambient sample to the accelerated storage test the content of emamectin benzoate, fipronil and lambda-cyhalothrin was found to be the almost same, that is 2.13, 9.99 and 4.98 respectively. It indicates that the content of emamectin benzoate, fipronil and lambda-cyhalothrin was degraded only by 3.2% w/w, 0.1% w/w, 0.4% w/w respectively and falls within the product specification range and hence the content of the active ingredients in the formulation is stable.

The pH of the ambient sample of the ZC formulation before subjecting it to the accelerated storage test was found to be 5.60. However, even after subjecting the ambient sample to the accelerated storage test the pH was found to be almost same, that is 5.58. It indicates that the ZC formulation was adhering to the pH range of 3.50-6.50 which indicates that the formulation is stable.

Tests such as persistent foam and pourability and wet sieve passing test were conducted for the ambient sample of the ZC formulation, before and after accelerated storage test. The results indicated that persistent foam test showed low persistent foam of 18 ml and 20 ml indicating the less froth formation and pourability test showed low rinse residue of 0.52% and 0.51% indicating less wastage of the formulation.

The suspensibility test and spontaneity of dispersion test was conducted for the ambient sample of the ZC formulation, before and after accelerated storage test. The results of the suspensibility test indicated that, 100% of emamectin benzoate, 97.42% and 97.29% of fipronil and 95.90% and 95.76% of lambda-cyhalothrin are uniformly distributed in water after dilution. The spontaneity of dispersion test results showed that 98.98% and 98.85% of formulation was dispersed uniformly and formed homogeneous suspension spontaneously. The wet sieve passing test showed passing of 99.94% w/w and 99.90% w/w of particles of the formulation through the 75p wet sieve indicating the low particle size of the formulation.

Thus, in all the tests, values of the tests remained almost same before and after accelerated storage test which indicates that the formulation is stable.

In view of the above test results, ZC formulation of the present invention prepared in accordance with the above examples are extrapolated to be stable for 2 years.

The advantages of the ZC formulation of the present invention include storage stability, environmental friendly due to the usage of non flammable and biodegradable solvents, easy to handle and measure, offer good dilutability with water, provides improved safety while maintaining insecticidal efficacy, also due to encapsulation of lambda-cyhalothrin it gradually diffuses over a long period of time and hence last longer and imparts long lasting protection against a wider variety of insect pests and repetitive spray application will also be avoided.

### Example 3

Water Dispersible Granule (WDG) Formulation in Accordance with the Present Invention

### I. Preparation of the Water Dispersible Granule (WDG) Formulation

### 1. Composition

As per some specific exemplary embodiments water dispersible granule (WDG) formulation were prepared with formulations as per Table 5:

TABLE 5
Composition for water dispersible granule
(WDG) of the present invention.

| | Example 3 |
|---|---|
| Ingredients | % w/w |
| Emamectin benzoate | 2.20 |
| Fipronil | 10.0 |
| Lambda-cyhalothrin | 5.0 |
| Tergitol ECO-36 | 5.0 |
| Polyalkoxylated butyl ether | 2.0 |
| Citric acid anhydrous | 0.50 |
| Disodium hexadecyl sulphate | 0.5 |
| sodium salt of naphthalene formaldehyde condensate | 5.0 |
| Polydimethyl siloxane | 0.5 |
| Hydrophobic fumed silica | 6.0 |
| N,N-Dimethyldecanamide (Rhodiasolv ® Adma 10) | 5.0 |
| Corn starch | Q.S. |

### 2. Process for Preparing the Water Dispersible Granule (WDG) Formulation

An N,N-dimethyldecanamide (Rhodiasolv® Adma 10), ethoxylated ricinoleic acid triglycerides (Tergitol ECO-36), polyalkoxylated butyl ether, lambda-cyhalothrin as mentioned in Example 3 were added into the dry mixing vessel fitted with stirrer and all the ingredients were mixed for 30 minutes with the stirrer to obtain a lambda-cyhalothrin solution. An active ingredients fipronil and emamectin benzoate along with citric acid anhydrous, disodium hexadecyl sulphate, sodium salt of naphthalene formaldehyde condensate, polydimethylsiloxane, hydrophobic fumed silica, corn starch, as mentioned in Example 3 were added into the dry pre blender and were mixed for 1 hour to obtain a pre-blended powder. The pre-blended powder was grinded through an air jet mill to obtain a milled powder of desirable particle size of d(90)<12 microns. The milled powder was homogenised for 2 hours in the post blender to obtain a homogeneous powder. The homogeneous powder was added into the dough maker and lambda-cyhalothrin solution was added into it and mixed well to preparm uniform dough. The uniform dough was extruded in basket extruder to obtain extruded granules. The extruded granules were dried in a fluid bed dryer to obtain the water dispersible granule (WDG) formulation.

### II. Accelerated Storage Test (Stability Study)

According to the FAO/WHO manual, the “accelerated storage test” is considered as an indicative of product stability. That is accelerated storage test data provides an indication that the product is stable for at least two years at ambient temperature. Further, the FAO/WHO manual indicates storage at 54° C.±2° C. for 14 days as the default test conditions.

The “ambient sample” is the sample at the room temperature which is before subjecting to the accelerated storage tests at 54±2° C. for 14 days.

The “accelerated storage sample” is the sample after subjecting to the accelerated storage test. The ambient samples of the water dispersible granule (WDG) formulation of the above Example 3 were subjected to the accelerated storage test to find out the product stability.

Table 6 shows the physical and chemical properties of the water dispersible granule (WDG) of Example 3 before and after the accelerated storage test.

TABLE 6
Physical and chemical properties of the water dispersible granule
(WDG) of Example 3 before and after the accelerated storage test.

| | | | | | Accelerated |
|---|---|---|---|---|---|
| | | | | | Storage Sample |
| | | | | | Tested @ |
| | | | | Ambient | 54 ± 2° C. |
| S. | | | Product | Sample | For 14 Days |
| No. | Tests | | Specifications | (Before) | (After) |
| 1 | Appearance | | Off white to cream | Complies | Complies |
| | | | coloured granules | | |
| | | | free from visible | | |
| | | | extraneous matter. | | |
| 2 | Active | Emamectin | Content: | 2.20 | 2.16 (1.8%*) |
| | Ingredient/ | benzoate | 2.09-2.42 | | |
| 3 | content | Fipronil | Content: | 10.00 | 9.99 0.1%*) |
| | test % | | 9.50-10.50 | | |
| 4 | w/w | Lambda | Content: | 5.00 | 4.98 (0.4%*) |
| | | cyhalothrin | 4.75-5.50 | | |
| 5 | Suspensibility | Emamectin | Min. 70 | 100.0 | 100.0 |
| | (% w/w) | benzoate | | | |
| 6 | | Fipronil | Min. 70 | 97.16 | 97.29 |
| 7 | | Lambda | Min. 70 | 96.55 | 96.79 |
| | | cyhalothrin | | | |

| | | | | |
|---|---|---|---|---|
| 8 | Wettability Sec | Max. 120 | 20 | 20 |
| 9 | Wet sieve passing | Min. 98.0 | 99.86 | 99.84 |
| | through 75 micron | | | |
| | test sieve (% w/w) | | | |
| 10 | Degree of dispersion | Min. 70 | 94.76 | 94.29 |
| | (% w/w) | | | |
| 11 | Persistent foam after | Max. 60 | 18 | 20 |
| | 1 min, mL | | | |
| 12 | pH of 1% Aq. | 3.50-6.50 | 5.60 | 5.58 |
| | Dispersion | | | |
| 13 | Dust content, mg | Max. 30 | 5 | 4 |

Min. = Minimum
Max. = Maximum
Sec. = Second

The results in Table 6 show that the appearance of the ambient sample of the water dispersible granule (WDG) before and after the accelerated storage test (@54±2° C. for 14 days) remained the same that is ‘off white to cream coloured granules free from visible extraneous matter’.

Further, the content of emamectin benzoate, fipronil and lambda-cyhalothrin was found to be 2.20% w/w, 10.00% w/w, 5.00% w/w, respectively before subjecting the ambient sample to the accelerated storage test. After subjecting the ambient sample to the accelerated storage test the content of emamectin benzoate, fipronil and lambda-cyhalothrin was found to be the almost same, that is 2.16 w/w, 9.99 w/w, 4.98 w/w respectively. It indicates that the content of emamectin benzoate, fipronil and lambda-cyhalothrin was degraded only by 1.8%, 0.1% and 0.4% respectively and falls within the product specification range and hence the content of the active ingredients in the formulation is stable.

The pH of the ambient sample of the water dispersible granule (WDG) before subjecting it to the accelerated storage test was found to be 5.60. However, even after subjecting the ambient sample to the accelerated storage test the pH was found to be almost same, that is 5.58. It indicates that the water dispersible granule (WDG) was adhering to the pH range of 3.50-6.50 which indicates that the formulation is stable.

The suspensibility test was conducted for the ambient sample of the water dispersible granule (WDG) formulation, before and after accelerated storage test. The results of the suspensibility test indicated that, 100% of emamectin benzoate, 97.16% and 97.29% of fipronil and 96.55% and 96.79% of lambda-cyhalothrin arm uniformly distributed in water after dilution

Tests such as persistent foam, wettability and degree of dispersion and dust content were also conducted for the ambient sample of the water dispersible granule (WDG), before and after accelerated storage test. The results indicated that persistent foam test showed low persistent foam of 18 ml and 20 ml indicating the less froth formation. The wettability test showed that the time taken to wet the granules is only 20 seconds indicating the faster dispersion and disintegration of the granules upon water dilution. Degree of dispersion test showed that 94.76% and 94.29% of granules were dispersed uniformly and formed homogeneous dispersion. Dust content test showed low dust generation of 5 mg and 4 mg indicating very less dust generation during handling, transportation and storage. The wet sieve passing test showed passing of 99.86% w/w and 99.84% w/w of particles of the formulation through the 75μ wet sieve indicating the low particle size of the formulation.

Thus, in all the tests, values of the tests remained almost same before and after accelerated storage test which indicates that the formulation is stable.

In view of the above test results, water dispersible granule (WDG) of the present invention prepared in accordance with the above examples are extrapolated to be stable for 2 years.

The advantages of the water dispersible granule (WDG) formulation of the present invention include storage stability, no dust and inhalation hazard to the applicator during handling, no usage of flammable solvents, no problem of toxicity, easily measured and diluted, empties out completely from the container, less chance of spillage, better physico-chemical stability, high degree of dispersion in water for spray applications, environmental friendly, easy and safe packaging and transportation.

### Example 4: Field Tests

The oil-dispersion (OD) of Example 1 and water dispersible granule (WDG) formulation of Example 3 was tested for its biological activity and the results are shown in Tables 7 to 8 below:

TABLE 7
Field test results of the emamectin benzoate, fipronil and lambda-cyhalothrin
oil-dispersion (OD) and water dispersible granule (WDG) formulation applied
against thrips in chilli at Karnataka location in the Rabi season 2022.

| | | | | | | % |
|---|---|---|---|---|---|---|
| | | | | Mean no. of | | Reduction |
| | | | | thrips/ leaf | | over |
| | | Dosage | | (DAA) | | UTC |
| | | | Formulation | | 10 | (10 |
| Types | Treatment | g a.i./ha | (g/ml/ha) | Before | DAA | DAA) |
| Example 1 | Emamectin | 11 + 25 + 50 | 500 | 2.67 | 0.93 | 88.62 |
| | Benzoate 2.2% + | | | | | |
| | Fipronil 10% + | | | | | |
| | Lambda | | | | | |
| | Cyhalothrin 5% | | | | | |
| | OD | | | | | |
| Example 3 | Emamectin | 11 + 25 + 50 | 500 | 2.73 | 0.87 | 89.43 |
| | Benzoate 2.2% + | | | | | |
| | Fipronil 10% + | | | | | |
| | Lambda cyhalothrin | | | | | |
| | 5% WDG | | | | | |
| Individual | Emamectin | 11 | 200 | 2.67 | 5.73 | 30.08 |
| ingredients | Benzoate 5% SG | | | | | |
| | Lambda cyhalothrin | 25 | 300 | 3.17 | 3.23 | 60.57 |
| | 5% EC | | | | | |
| | Fipronil 5% SC | 50 | 1000 | 3.67 | 2.8 | 65.85 |
| Conventional | Emamectin | 7.5 + 17.5 | 500 | 2.87 | 2.83 | 65.45 |
| Combinations | Benzoate 1.5% + | | | | | |
| | Fipronil 3.5% SC | | | | | |
| | Chlorantraniliprole | 18.60 + 9.2 | 200 | 3.07 | 3.13 | 61.79 |
| | 9.30% + Lambda- | | | | | |
| | cyhalothrin 4.60% | | | | | |
| | ZC | | | | | |
| Untreated | — | — | — | 2.77 | 8.2 | 0.00 |
| check | | | | | | |

DAA—Days after application

As seen from the above results, 10 days after application of the OD and WDG formulation of the insecticide composition comprising emamectin benzoate in an amount of 2.20%, fipronil in an amount of 10.00% and lambda-cyhalothrin in an amount of 5% at the application rate of 500 g/ml per hectare (g/ml/ha), the thrips population was reduced to the greater extent that is 88.62% and 89.43% percent reduction of the thrips respectively in comparison to the untreated check.

The results were better in comparison to the individual compounds emamectin Benzoate, fipronil and lambda-cyhalothrin. That is the registered formulation of emamectin benzoate 5% SG alone at the application rate of 200 g/ml per hectare showed 30.08% reduction of the thrips. And, the registered formulation of lambda cyhalothrin 5% EC alone at the application rate of 300 g/ml per hectare showed only 60.57% reduction of the thrips. Likewise, the registered formulation of fipronil 5% SC alone at the application rate of 1000 g/ml per hectare showed only 65.85% reduction of the thrips.

Further, the results exhibited by the OD and WDG formulation of the present invention was better in comparison to the conventional combinations and formulations available in the market such as emamectin benzoate 1.5%+fipronil 3.5% SC and chlorantraniliprole 9.3%+lambda cyhalothrin 4.6% ZC.

That is emamectin benzoate 1.5%+fipronil 3.5% SC, at the application rate of 500 g/ml per hectare showed only 65.45% reduction of the thrips which is 23.17% and 23.98% lesser than the thrips reduction of the present invention (88.62 and 89.43%). Further, chlorantraniliprole 9.3%+lambda cyhalothrin 4.6% ZC at the application rate of 200 g/ml per hectare showed only 61.79% reduction of the thrips which is 26.83% and 27.64% lesser than the thrips reduction of the present invention (88.62% and 89.43%).

Similarly, the results of Tables 8 shows that the compositions comprising emamnectin benzoate, fipronil and lamnbda-cyhalothrin formulated into OD and WDG resulted in greater than 87% reduction of Spodoptera litura in comparison to the untreated check. Also, the percentage reduction of Spodoptera litura by the present composition is higher than the individual compounds as well as conventional combination.

TABLE 8
Field test results of the emamectin benzoate, fipronil and lambda-cyhalothrin oil-
dispersion (OD) and water dispersible granule (WDG) formulation applied against
spodoptera litura in chilli at Karnataka location in the Rabi season 2022.

| | | | | Mean no. of | | % |
|---|---|---|---|---|---|---|
| | | | | Spodoptera | | Reduction |
| | | | | litura larvae/ | | over |
| | | Dosage | | plant | | UTC |
| | | | Formulation | | 10 | (10 |
| Types | Treatment | g a.i./ha | (g/ml/ha) | Before | DAA | DAA) |
| Example 1 | Emamectin Benzoate | 11 + 25 + 50 | 500 | 2.70 | 0.37 | 87.64 |
| | 2.2% + Fipronil 10% + | | | | | |
| | Lambda Cyhalothrin | | | | | |
| | 5% OD | | | | | |
| Example 3 | Emamectin Benzoate | 11 + 25 + 50 | 500 | 2.67 | 0.37 | 87.42 |
| | 2.2% + Fipronil 10% + | | | | | |
| | Lambda Cyhalothrin | | | | | |
| | 5% WDG | | | | | |
| Individual | Emamectin Benzoate | 11 | 200 | 2.33 | 1 | 66.29 |
| ingredients | 5% SG | | | | | |
| | Lambda cyhalothrin | 25 | 300 | 2.67 | 1.03 | 65.17 |
| | 5% EC | | | | | |
| | Fipronil 5% SC | 50 | 1000 | 3.00 | 1.97 | 33.71 |
| Conventional | Emamectin Benzoate | 7.5 + 17.5 | 500 | 2.67 | 1.87 | 37.08 |
| Combinations | 1.5% + Fipronil 3.5% | | | | | |
| | SC | | | | | |
| Untreated | | — | — | 2.17 | 2.97 | 0.00 |
| check | | | | | | |

DAA—Days after application

Accordingly, the above test results show unexpected and surprising results proving the synergistic effect of the combination of emamectin benzoate, fipronil and lambda-cyhalothrin in the control of thrips and Spodoptera litura in the chilli fields. As can be seen from Tables 7 and 8, the combined administration of emamectin benzoate, fipronil and lambda-cyhalothrin resulted in significant reduction in insect population as compared to single administration of the individual insecticides. It is also evident that the combination in accordance with the present invention exhibits a superior insecticidal effect as compared to other known registered insecticide combination products available in the market.

The foregoing examples are merely illustrative and are not to be taken as limitations upon the scope of the invention. Various changes and modifications to the disclosed examples will be apparent to those skilled in the art. Such changes and modifications may be made without departing from the scope of the invention.

We claim:

1. An insecticide composition comprising the active ingredients emamectin benzoate, fipronil, lambda-cyhalothrin and one or more inactive excipient(s) selected from the group comprising of a pH stabilizer, an emulsifier, a dispersing agent, stabilizing agent, wetting agent, spreading agent, anti-foaming agent, rheology modifier, solvent, capsule forming agent, quenching agent, super spreader, an anti-freezing agent, a biocide, an anti-caking agent, an inert carrier or combination thereof.

2. The insecticide composition as claimed in claim 1, wherein the composition comprises emamectin benzoate in an amount of from 0.1% to 20% w/w, fipronil in an amount of from 0.1% to 40% w/w and lambda-cyhalothrin in an amount of from 0.1% to 30% w/w, a pH stabilizer in an amount of from 0.01% to 10% w/w, an emulsifier in an amount of from 0.1% to 20% w/w, a dispersing agent in an amount of from 0.1% to 15% w/w, stabilizing agent in an amount of from 0.01% to 10% w/w, wetting agent in an amount of from 0.1% to 15% w/w, spreading agent in an amount of from 0% to 10% w/w, anti-foaming agent in an amount of from 0.01% to 5% w/w, rheology modifier in an amount of from 0.01% to 10% w/w, solvent in an amount of from 0.01% to 90% w/w, capsule forming agent in an amount of from 0.01% to 5% w/w, quenching agent in an amount of from 0.01% to 10% w/w, super spreader in an amount of from 0% to 10% w/w, an anti-freezing agent in an amount of from 0.01 to 15% w/w, a biocide in an amount of from 0.01 to 5% w/w, an anti-caking agent in an amount of from 0.01% to 10% w/w or an inert carrier in an amount of from 1% to 90% w/w.

3. An insecticide formulation comprising the active ingredients emamectin benzoate, fipronil, lambda-cyhalothrin one or more inactive excipient(s) selected from the group comprising of a pH stabilizer, an emulsifier, a dispersing agent, stabilizing agent, wetting agent, spreading agent, anti-foaming agent, rheology modifier, solvent, capsule forming agent, quenching agent, super spreader, an anti-freezing agent, a biocide, an anti-caking agent, an inert carrier or combination thereof.

4. The insecticide formulation as claimed in claim 3, wherein the formulation comprises emamectin benzoate in an amount of from 0.1% to 20% w/w, fipronil in an amount of from 0.1% to 40% w/w and lambda-cyhalothrin in an amount of from 0.1% to 30% w/w, a pH stabilizer in an amount of from 0.01% to 10% w/w, an emulsifier in an amount of from 0.1% to 20% w/w, a dispersing agent in an amount of from 0.1% to 15% w/w, stabilizing agent in an amount of from 0.01% to 10% w/w, wetting agent in an amount of from 0.1% to 15% w/w, spreading agent in an amount of from 0% to 10% w/w, anti-foaming agent in an amount of from 0.01% to 5% w/w, rheology modifier in an amount of from 0.01% to 10% w/w, solvent in an amount of from 0.01% to 90% w/w, capsule forming agent in an amount of from 0.01% to 5% w/w, quenching agent in an amount of from 0.01% to 10% w/w, super spreader in an amount of from 0% to 10% w/w, an anti-freezing agent in an amount of from 0.01 to 15% w/w, a biocide in an amount of from 0.01 to 5% w/w, an anti-caking agent in an amount of from 0.01% to 10% w/w or an inert carrier in an amount of from 1% to 90% w/w.

5. The insecticide formulation as claimed in claim 3, wherein the formulation is selected from oil-dispersion (OD), ZC formulation (ZC), water-dispersible granule (WDG), a water-soluble granule (SG), a wettable powder (WP), a water-dispersible powder (WDP), a water-soluble powder (SP), a granule (GR), an encapsulated granule (CG), a fine granule (FG), a macrogranule (GG), a microgranule (MG), a suspension concentrate (SC), a water-soluble concentrate (SL), a flowable suspension (FS), soil applied granules (SAG), dustable powder (DP), a gel, a water-dispersible tablet (WT), a dispersible concentrate (DC) or a microencapsulated suspension (CS).

6. The insecticide formulation as claimed in claim 5, wherein the formulation is an oil-dispersion (OD).

7. The insecticide formulation as claimed in claim 6, wherein the oil-dispersion (OD) formulation comprises:
a) 0.1% to 20.0% emamectin benzoate by weight of the formulation
b) 0.1% to 40.0% fipronil by weight of the formulation;
c) 0.1% to 30.0% lambda-cyhalothrin by weight of the formulation;
d) 0.01% to 10.0% pH stabilizer by weight of the formulation;
e) 0.1% to 20.0% emulsifier by weight of the formulation;
f) 0.1% to 15.0% dispersing agent by weight of the formulation;
g) 0.01% to 10.0% stabilizing agent by weight of the formulation;
h) 0.1% to 15.0% wetting agent by weight of the formulation;
i) 0% to 10.0% spreading agent by weight of the formulation;
j) 0.01% to 5.0% antifoaming agent by weight of the formulation;
k) 0.01% to 10.0% rheology modifier by weight of the formulation; and
l) 0.01% to 90.0% solvent by weight of the formulation.

8. The insecticide formulation as claimed in claim 7, wherein the oil-dispersion (OD) comprises:
a) 0.1% to 20.0% emamectin benzoate by weight of the formulation;
b) 0.1% to 40.0% fipronil by weight of the formulation;
c) 0.1% to 30.0% lambda-cyhalothrin by weight of the formulation;
d) 0.01% to 10.0% pH stabilizer by weight of the formulation selected from the group comprising of sodium acetate, trisodium phosphate, trisodium citrate, oxalic acid, citric acid anhydrous or mixture thereof;
e) 0.1% to 20.0% emulsifier by weight of the formulation selected from the group comprising of ethoxylated propoxylated alcohols, alkylphenolethoxylates, alkoxylated tristyrylphenols, ethoxylated propoxylated polyaryl phenol, ethoxylated fatty acids, ethoxylated ricinoleic acid triglycerides, castor oil ethoxylate or mixtures thereof;
f) 0.1% to 15.0% dispersing agent by weight of the formulation selected from the group comprising of naphthalene formaldehyde condensates, polycarboxylates, calcium dodecylbenzene sulfonate, polystyrenated acrylated co-polymer, salts of phenol sulfonic acids, random co-polymer of alcoxylated polyethylene glycol or mixtures thereof;
g) 0.01% to 10.0% stabilizing agent by weight of the formulation selected from the group comprising of precipitated silica, polyvinylpyrrolidone (PVP) or mixtures thereof;
h) 0.1% to 15.0% wetting agent by weight of the formulation selected from the group comprising of sodium alkyl naphthalene sulfonate, alpha olefin sulfonates, disodium laureth sulfosuccinate, diisodecyl sodium sulfosuccinate, alkyl sulfosuccinic monoesters, dioctyl sulfosuccinate sodium salt or mixtures thereof;
i) 0% to 10.0% spreading agent by weight of the formulation selected from the group comprising of polyoxyethylene alkyl ether, trisiloxane ethoxylate, polysorbates, sodium lauryl sulphate, tridecyl alcohol ethoxylate or mixtures thereof;
j) 0.01% to 5.0% antifoaming agent by weight of the formulation selected from the group comprising perfluroalkylphosphonic acids, polydimethyl siloxane or mixtures thereof;
k) 0.01% to 10.0% rheology modifier by weight of the formulation selected from the group comprising of fume silica, bentonite, hydroxymethyl cellulose, xanthan gum, thickening silica, hydrated clay minerals, magnesium aluminium silicates, organic derivative of hectorite clay, hydrophobic fumed silica or mixture thereof; and
l) 0.01% to 90.0% solvent by weight of the formulation selected from the group comprising of oil medium selected from the group comprising, esterified fatty acids selected from methyl ester of triglycerides containing C₁₂-C₂₂ saturated and unsaturated fatty acids, ethyl ester of triglycerides containing C₁₂-C₂₂ saturated and unsaturated fatty acids such as methyl soyate, ethyl soyate, rapeseed methyl ester, rapeseed ethyl ester or mixtures thereof.

9. A process for preparing the oil-dispersion (OD) as claimed in claim 7, the process comprises,
a) mixing one or more excipients along with an oil medium to obtain a mixture;
b) adding emamectin benzoate, fipronil and lambda-cyhalothrin to the mixture and continuing to mix to obtain a slurry;
c) passing the slurry through a mill for particle size reduction to obtain a milled slurry; and
d) adding a rheology modifier to the milled slurry and continuing to mix to obtain a homogeneous oil dispersion (OD).

10. The process for preparing the oil-dispersion (OD) as claimed in claim 9, wherein inactive excipients are selected from the group comprising of a pH stabilizer, an emulsifier, a dispersing agent, stabilizing agent, wetting agent, spreading agent, anti-foaming agent, rheology modifier, solvent or combination thereof.

11. The insecticide formulation as claimed in claim 5, wherein the formulation is a ZC formulation

12. The insecticide formulation as claimed in claim 11, wherein the ZC formulation comprises:
a) 0.1% to 20.0% emamectin benzoate by weight of the formulation;
b) 0.1% to 40.0% fipronil by weight of the formulation;
c) 0.1% to 30.0% lambda-cyhalothrin by weight of the formulation;
d) 0.01% to 90.0% solvent by weight of the formulation;
e) 0.01% to 5% capsule forming agent by weight of the formulation;
f) 0.01% to 10% quenching agent by weight of the formulation;
g) 0% to 10% super spreader by weight of the formulation;
h) 0.1% to 20.0% emulsifier by weight of the formulation;
i) 0.1% to 15.0% dispersing agent by weight of the formulation;
j) 0.1% to 15.0% wetting agent by weight of the formulation;
k) 0.01% to 15.0% anti-freezing agent by weight of the formulation;
l) 0.01 to 5% biocide by weight of the formulation;
m) 0.01% to 5.0% antifoaming agent by weight of the formulation;
n) 0.01% to 10.0% pH stabilizer by weight of the formulation; and
o) 0.01% to 10.0% rheology modifier by weight of the formulation.

13. The insecticide formulation as claimed in claim 12, wherein the ZC formulation:
a) 0.1% to 20.0% emamectin benzoate by weight of the formulation;
b) 0.1% to 40.0% fipronil by weight of the formulation;
c) 0.1% to 30.0% lambda-cyhalothrin by weight of the formulation;
d) 0.01% to 90.0% solvent by weight of the formulation selected from the group comprising of deionized (DI) water, demineralised water, N,N-dimethyldecanamide, or mixtures thereof;
e) 0.01% to 5% capsule forming agent by weight of the formulation selected from the group comprising of methylene diisocyanate, toluene diisocyanate or mixtures thereof;
f) 0.01% to 10% quenching agent by weight of the formulation selected from the group comprising of ethylene diamine (EDA), ethanol-amine, butadiene, ammonia solution (25%) or mixture thereof;
g) 0% to 10% super spreader by weight of the formulation selected from the group comprising of trisiloxane alkoxylate, modified trisiloxane or mixture thereof;
h) 0.1% to 20.0% emulsifier by weight of the formulation selected from the group comprising of ethoxylated or propoxylated alkylaryl phosphate ester, polycondensates of ethylene oxide with fatty alcohols ethoxylated alcohols, alkylphenolethoxylates, alkoxylated tristyrylphenols, calcium dodecylbenzene sulfonate or mixture thereof;
i) 0.1% to 15.0% dispersing agent by weight of the formulation selected from the group comprising of naphthalene formaldehyde condensates, polycarboxylates, polystyrenated acrylated co-polymer, ethopropoxylated polyarylphenol phosphate amine salt, sodium lignosulfonate, polymethyl methacrylate-polyethylene glycol graft copolymer or mixture thereof;
j) 0.1% to 15.0% wetting agent by weight of the formulation selected from the group comprising of alkyl naphthalene sulfonates, dioctyl sulfosuccinate sodium salt, alpha olefin sulfonates, alkyl ether sulphates, C₁₂₋₁₅ alcohol ethoxylate or mixture thereof;
k) 0.01% to 15.0% anti-freezing agent by weight of the formulation selected from the group comprising of ethylene glycol, glycerine, urea, propylene glycol or mixture thereof;
l) 0.01 to 5% biocide by weight of the formulation selected from the group comprising of formaldehyde, 1,2-benzisothiazolin-3-one or mixtures thereof;
m) 0.01% to 5.0% antifoaming agent by weight of the formulation selected from the group comprising of perfluroalkylphosphonic acids, polydimethyl siloxane or mixture thereof;
n) 0.01% to 10.0% pH stabilizer by weight of the formulation selected from the group comprising of sodium pyrophosphate, sodium acetate, sodium acetate, trisodium phosphate, trisodium citrate, triethanol amine, citric acid anhydrous, ortho phosphoric acid or mixture thereof; and
o) 0.01% to 10.0% rheology modifier by weight of the formulation selected from the group comprising of hydrophobic fumed silica, bentonite, xanthan gum, polysaccharide gel or mixtures thereof.

14. A process for preparing the ZC formulation as claimed in claim 12, the process comprises,
i) preparing microencapsulated Lambda-cyhalothrin (CS) comprising steps of:
a) preparing an oil phase by mixing molten lambda-cyhalothrin with N, N-dimethyldecanamide followed by addition of one or more capsule forming agent(s);
b) preparing an aqueous phase by adding one or more inactive excipient(s) in demineralised water and mixing for about 15 minutes to about 60 minutes;
c) charging the oil phase into the aqueous phase at an elevated temperature and mixing to form an emulsion;
d) quenching the emulsion with an aqueous ammonia solution;
e) maintaining the emulsion under stirring for a time period of about 30 minutes to 5 hours;
f) adjusting the pH in the range of 4.5 to 6.5 and cooling the emulsion to room temperature to obtain microencapsulated Lambda-cyhalothrin;
ii) preparing emamectin benzoate and fipronil combination suspension concentrates (SC) comprising steps of:
a) adding one or more inactive excipient(s) in demineralised water and mixing for about 15 minutes to about 60 minutes to form a mixture;
b) adding emamectin benzoate, fipronil to the mixture and continuing to mix to obtain a slurry.
c) passing the slurry through a mill for particle size reduction to obtain a homogeneous suspension concentrate (SC);
iii) preparing ZC formulation comprising steps of:
a) mixing the microencapsulated lambda-cyhalothrin and the suspension concentrate of emamectin benzoate and fipronil combination along with a super spreader for about 15 minutes to 90 minutes to form a homogeneous mixture; and
b) adding rheology modifier to the obtained homogeneous mixture and continuing to mix for about 3 hours to about 7 hours to obtain a ZC formulation (ZC).

15. The process for preparing the ZC formulation as claimed in claim 14, wherein inactive excipients are selected from the group comprising of a solvent, capsule forming agent, quenching agent, super spreader, an emulsifier, a dispersing agent, wetting agent, an anti-freezing agent, a biocide, anti-foaming agent, a pH stabilizer, rheology modifier or combination thereof.

16. The insecticide formulation as claimed in claim 5, wherein the formulation is a water-dispersible granule (WDG) formulation.

17. The insecticide formulation as claimed in claim 16, wherein the water-dispersible granule (WDG) formulation comprises:
a) 0.1% to 20.0% emamectin benzoate by weight of the formulation;
b) 0.1% to 40.0% fipronil by weight of the formulation;
c) 0.1% to 30.0% lambda-cyhalothrin by weight of the formulation;
d) 0.1% to 20.0% emulsifier by weight of the formulation;
e) 0.1% to 15.0% dispersing agent by weight of the formulation;
f) 0.01% to 10.0% pH stabilizer by weight of the formulation;
g) 0.1% to 15.0% wetting agent by weight of the formulation;
h) 0.01% to 5.0% antifoaming agent by weight of the formulation;
i) 0.01% to 10.0% anti-caking agent by weight of the formulation;
j) 0.01% to 90.0% solvent by weight of the formulation; and
k) 1% to 90.0% inert carrier by weight of the formulation.

18. The insecticide formulation as claimed in claim 17, wherein the water-dispersible granule (WDG) formulation comprises:
a) 0.1% to 20.0% emamectin benzoate by weight of the formulation;
b) 0.1% to 40.0% fipronil by weight of the formulation;
c) 0.1% to 30.0% lambda-cyhalothrin by weight of the formulation;
d) 0.1% to 20.0% emulsifier by weight of the formulation selected from the group comprising of calcium dodecylbenzene sulfonate, alkoxylated alcohols, tristyryphenol ethoxylate, ethoxylated fatty acids, ethoxylated ricinoleic acid triglycerides, castor oil ethoxylate or mixtures thereof;
e) 0.1% to 15.0% dispersing agent by weight of the formulation selected from the group comprising of lignosulphonates, polycarboxylates, calcium dodecylbenzene sulfonate, polymethyl methacrylate-polyethylene glycol graft copolymer, polyalkoxylated butyl ether, sodium salt of naphthalene formaldehyde condensate or mixtures thereof;
f) 0.01% to 10.0% pH stabilizer by weight of the formulation selected from the group comprising of sodium acetate, trisodium phosphate, trisodium citrate, ortho phosphoric acid, oxalic acid, citric acid anhydrous or mixtures thereof;
g) 0.1% to 15.0% wetting agent by weight of the formulation selected from the group comprising of alkyl naphthalene sulfonates, dioctyl sulfosuccinate sodium salt, alkyl ether sulphates, disodium hexadecyl sulphate or mixtures thereof;
h) 0.01% to 5.0% antifoaming agent by weight of the formulation selected from the group comprising of perfluroalkylphosphonic acids, polydimethyl siloxane or mixture thereof;
i) 0.01% to 10.0% anti-caking agent by weight of the formulation selected from the group comprising of precipitate silica, hydrophobic fumed silica or mixtures thereof;
j) 0.01% to 90.0% solvent by weight of the formulation selected from the group comprising of deionized (DI) water, diisobutyl ester, 5-(dimethylamino)-2-methyl-5-oxopentanoate, N,N-dimethyldecanamide or mixtures thereof; and
k) 1% to 90.0% inert carrier by weight of the formulation selected from the group comprising of kaolin, china clay, precipitated silica, bentonite, corn starch or mixtures thereof.

19. A process for preparing the water-dispersible granule (WDG) formulation as claimed in claim 17, the process comprises,
a) mixing lambda-cyhalothrin with one or more excipients for 15 minutes to 60 minutes to obtain a lambda-cyhalothrin solution;
b) mixing fipronil and emamectin benzoate with one or more excipient(s) for 30 minutes to 4 hours to obtain a pre-blended powder;
c) grinding the pre-blended mixture through a mill to obtain a milled powder of desirable particle size of d(90)<12 microns;
d) homogenising the milled powder with desirable particle size for 1 hour to 4 hours to obtain a homogeneous powder;
e) adding the lambda-cyhalothrin solution to the homogeneous powder and mixing to prepare a uniform dough; and
f) extruding the uniform dough through an extruder to obtain extruded granules and drying the extruded granules in a dryer to obtain the water dispersible granule (WDG) formulation

20. The process for preparing the water dispersible granule (WDG) formulation as claimed in claim 19, wherein inactive excipients are selected from the group comprising of an emulsifier, a dispersing agent, a pH stabilizer, wetting agent, anti-foaming agent, an anti-caking agent, solvent, an inert carrier or combination thereof.
